(19) United States
(12) Patent Application Publication
(10) Pub. No.: US 2026/0244731 A1
(43) Pub. Date: Aug. 20, 2026

(54) Second Factor Authentication for Application Programming Interfaces

(71) Applicant: DigiCert, Inc., Lehi, UT (US)

(72) Inventors: Quentin Liu, San Jose, CA (US); Calista Liu, San Jose, CA (US)

(73) Assignee: DigiCert, Inc., Lehi, UT (US)

(21) Appl. No.: 19/058,456

(22) Filed: Feb. 20, 2025

(51) Int. Cl. G06F 21/40; G06F 9/54; H04L 9/32

(52) U.S. Cl. CPC G06F 21/40; G06F 9/54; H04L 9/3213; G06F 2221/2111

(57) ABSTRACT

A method is provided for second-factor authentication in API environments that binds API access to a client device's physical location, leveraging authorized Wi-Fi networks as a proximity-based factor. The client device registers a list of Wi-Fi networks and, upon detecting at least one such network, generates an encrypted token. This token includes data such as time-limited nonces and device identifiers, ensuring replay protection and verifiable authenticity. The token is transmitted alongside a first-factor credential (e.g., an API key, OAuth token, or mutual TLS certificate) in an API request to the server. The server validates the token using a cryptographic key to confirm that the client device is indeed at the legitimate physical location. If successful, the request proceeds, potentially allowing sensitive operations such as certificate management by a CA. The method includes preventing Wi-Fi spoofing via local handshakes, updating the network list securely, and maintaining audit logs for compliance.

### FIELD OF THE DISCLOSURE

The present disclosure relates generally to computing. More particularly, the present disclosure relates to systems and methods for second factor authentication for application programming interfaces (APIs).

### BACKGROUND OF THE DISCLOSURE

Application programming interfaces (APIs) allow software applications to communicate and exchange data with one another using predefined protocols and methods. In a typical scenario, an API client (such as a service or application) sends requests to a server that exposes an API, and the server returns structured responses. This interaction often relies on credentials (e.g., an API key, username/password pair, or OAuth token) to verify the identity of the caller and to ensure that only authorized entities can access specific resources. In many modern systems, these credentials are stored and used automatically by client-side code or server-to-server calls without requiring direct human involvement in each request. Although adding multi-factor authentication (MFA) is standard practice for user-facing logins, it becomes more challenging to implement when an API operates in a fully automated, machine-to-machine context. Human-driven MFA methods (like entering a one-time passcode from an SMS or authenticator app) are impractical if there is no user to respond to prompts. As a result, API-based services rely solely on a single factor, such as a secret token or password, embedded in the calling application. This opens the door to security risks: if an attacker obtains the single factor (e.g., the API key), they can impersonate legitimate requests.

### BRIEF SUMMARY OF THE DISCLOSURE

The present disclosure provides a practical solution for implementing multi-factor authentication (MFA) in API-driven environments where human intervention is impractical or impossible. By leveraging a list of pre-authorized, on-premises Wi-Fi networks as an additional layer of verification, i.e., a second factor of authentication, the system ensures that API calls are only valid when initiated in the legitimate customer's physical location. A client-side module verifies the presence of these registered Wi-Fi signals and generates an encrypted, non-replayable token, which is then sent to the API server alongside normal credentials. The server checks both the primary credentials and the token's authenticity and proximity information before granting access. This design not only bolsters security—thwarting attackers even if they acquire primary API keys—but also maintains fully automated, machine-to-machine operation without requiring specialized hardware or human interaction.

This approach to second-factor authentication offers multiple benefits for API security. It substantially reduces the risk of unauthorized access by tying API usage to the legitimate customer's physical location, so that even stolen credentials cannot be used from elsewhere. It preserves automation in machine-to-machine interactions, avoiding the typical user interaction pitfalls of MFA. Because it leverages existing Wi-Fi infrastructure—rather than requiring new hardware—this solution is both cost-effective and simple to deploy at scale. Furthermore, by embedding cryptographic measures and replay-prevention techniques, the approach provides robust protection against spoofing and interception. Overall, it boosts security without sacrificing operational efficiency, making it well suited for environments like certificate authorities, financial institutions, and enterprise information technology (IT) systems.

In various aspects, the present disclosure can be implemented as a method, a non-transitory computer-readable medium storing instructions, or a computing environment configured to provide second-factor authentication for application programming interfaces (APIs). This approach ensures that API calls can only originate from within a legitimate physical location. After registering a list of Wi-Fi networks associated with a valid site for a client device, the API server receives an API request containing both a first-factor credential and an encrypted token. The client device generates the token upon detecting at least one authorized Wi-Fi network from the registered list. The server then verifies the first-factor credential against known client devices and validates the encrypted token using a cryptographic key. If both are successfully authenticated, the API request is allowed to proceed, with the detected Wi-Fi network serving as a second factor that confirms the client device's physical presence. Additional embodiments encompass registering detailed Wi-Fi identifiers (e.g., SSID, BSSID, or MAC address), embedding time-limited nonces to reject replayed or expired tokens, scanning for on-premises access points that thwart SSID-only spoofing, verifying digital signatures, and supporting various first-factor credentials such as API keys or mutual TLS certificates. The method, medium, or computing environment may also employ local handshakes, secure transport protocols, hardware security modules, device-identifier verification, automatic Wi-Fi list updates, audit logging, granular privilege enforcement based on which Wi-Fi network is detected, and cryptographic proof of proximity to mitigate spoofing attempts.

### BRIEF DESCRIPTION OF THE DRAWINGS

The present disclosure is detailed through various drawings, where like components or steps are indicated by identical reference numbers for clarity and consistency.

FIG. 1 illustrates an example computing environment that depicts how multi-factor authentication (MFA) can be realized in an API-driven context without human interaction.

FIG. 2 illustrates a block diagram of a computing system that may be used to implement various components described in this disclosure.

FIG. 3 illustrates a flowchart of a process for providing second-factor authentication for an application programming interface (API) in a computing environment.

### DETAILED DESCRIPTION OF THE DISCLOSURE

Again, APIs often facilitate machine-to-machine interactions without any human user in the loop. This lack of human intervention makes traditional multi-factor authentication (MFA) methods impractical, since there is no person available to supply a second factor (like a one-time code or biometric). At the same time, ensuring strong security for API communication is crucial. Modern digital economies rely heavily on internet-based services for e-commerce transactions, enterprise data exchange, and digital trust services. For example, Certificate Authorities (CAs) may provide APIs to enterprise customers for managing critical digital certificate lifecycle operations. These high-value operations demand robust authentication measures to prevent unauthorized access. Relying solely on standard API keys or simple credentials (such as passwords or static tokens) is risky-if those credentials are ever compromised, an attacker could misuse the API. In summary, APIs need a stronger, second-factor authentication mechanism that works without human involvement, to protect sensitive transactions even if primary credentials are stolen.

### Challenges in Securing API Access

Traditional multi-factor authentication (MFA) relies on something the user knows (e.g., a password) combined with something the user has or is (e.g., a mobile device for a one-time passcode (OTP), a fingerprint, etc.). In the context of API scenarios, however, the client is an automated software agent rather than a human user, making it impossible to prompt for a one-time password or push-notification approval.

The following describes common “first-factor” authentication methods used in API security, detailing their typical use cases, strengths, and potential vulnerabilities:
(1) API Keys or Tokens. These are long-lived secrets or alphanumeric strings assigned to a specific client or application. Typically included in each request (via a Hypertext Transfer Protocol (HTTP) header or a query parameter), they serve to identify the caller. API keys or tokens are widely used for service-to-service calls (e.g., microservices or third-party integrations) because they are straightforward to implement. They are simple to deploy and can be revoked or rotated if compromised. However, if they are stored insecurely (e.g., embedded in source code or configuration files) and subsequently leaked, attackers can reuse them indefinitely. Furthermore, they do not inherently provide additional security properties (e.g., expiration or scope) unless the system is explicitly designed to enforce such constraints.
(2) HTTP Basic or OAuth Credentials. HTTP Basic: Credentials (i.e., username and password) are Base64-encoded and placed in an HTTP header. This approach is common in legacy systems or straightforward API calls where user credentials can be easily passed. OAuth: Clients obtain bearer tokens (access tokens) or use refresh tokens for longer sessions. OAuth provides more granular scopes and built-in token expiration mechanisms than Basic. OAuth is generally favored by modern web or mobile applications requiring delegated access and token-based session management. Both methods rely on secure credential storage. A stolen OAuth bearer token remains valid until it expires, whereas HTTP Basic credentials are static and can be replayed if intercepted without transport layer security (TLS).
(3) IP Allowlisting or Network Restrictions. In this approach, only requests originating from a set of approved IP addresses or subnets are permitted to access the API. It is common in enterprise environments for internal APIs or for protecting administrative endpoints, and is sometimes paired with virtual private networks (VPNs) or on-premises connections. Such allowlisting is relatively simple to configure and provides an additional barrier against indiscriminate, internet-wide attacks. However, it can be circumvented if an attacker compromises a machine within the approved network range or employs IP spoofing in less secure environments. Moreover, it lacks granular, per-user, or per-device security because it relies on network perimeter controls rather than individual authentication tokens or certificates.
(4) Mutual TLS (Client Certificates). In this method, the client must present a valid X.509 certificate signed by a recognized CA during the TLS handshake. The server verifies the client's certificate prior to granting access, thus ensuring both server and client trust each other. Mutual TLS enables highly secure API-to-API communication in zero-trust architectures, enterprise systems, and regulated sectors (e.g., finance, healthcare). It offers strong cryptographic guarantees that the client is who it claims to be, and it is resistant to credential theft if private keys are hardware-bound. Nevertheless, it requires careful certificate issuance and lifecycle management (e.g., renewal, revocation) along with secure private key storage. If a private key is compromised, attackers can impersonate the client until the certificate is revoked.

Overall, these first-factor authentication methods form the baseline for API security. However, relying on a single method (e.g., only an API key) can leave the system vulnerable if that key is exposed. In high-security scenarios—particularly where APIs handle sensitive or high-value transactions—an additional, second factor of authentication is desirable to mitigate risks associated with credential theft and unauthorized access. For instance, API keys and static tokens can be leaked or stolen, IP address filtering can be bypassed if an adversary gains a foothold within the network, and although Mutual TLS adds security, it still depends on safeguarding a private key. In each case, credential compromise can allow attackers to impersonate the legitimate client from any location.

The fundamental challenge is therefore how to incorporate a second authentication factor for a non-interactive client. The present disclosure provides a solution that ensures a stolen or compromised credential alone is insufficient for access, without adding manual steps that would disrupt the automated nature of API-driven workflows.

### Wi-Fi Proximity as a Second Factor

The present solution introduces a second-factor authentication mechanism for APIs that leverages physical location—specifically, the presence of the client device within the legitimate customer's network environment. The core idea is to bind API access to the device's physical proximity to a trusted network (for example, the corporate office's Wi-Fi network). By doing so, even if an attacker obtains the API credentials, they cannot execute API calls from an arbitrary location; the client will only function when it's on-premises or within an authorized area. This approach maintains full automation (no human input required), preserving the seamless machine-to-machine nature of API calls, while significantly enhancing security.

### Example Computing Environment

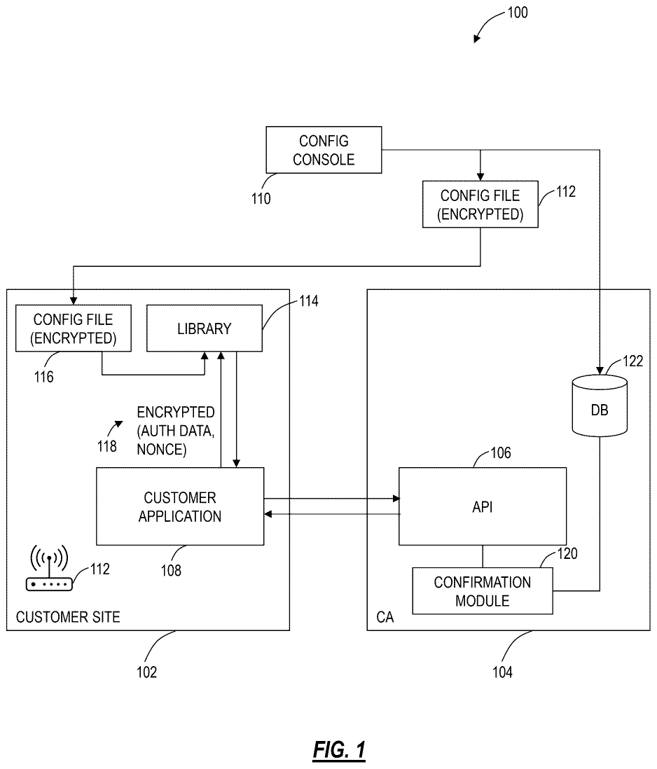

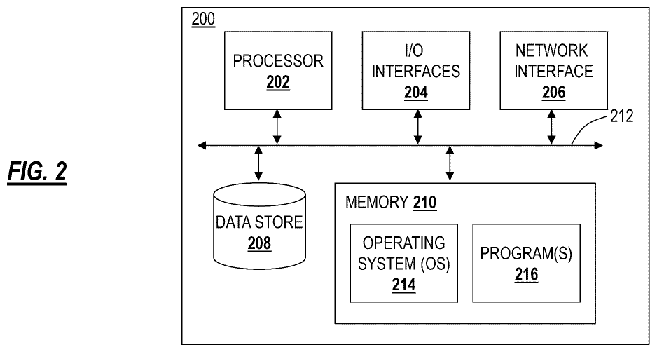

FIG. 1 illustrates an example computing environment 100 that depicts how multi-factor authentication (MFA) can be realized in an API-driven context without human interaction. In this environment, a customer site 102 communicates with a Certificate Authority (CA) 104 through an API 106 using a non-interactive client, namely a customer application 108. FIG. 1 should be understood as a logical representation; those skilled in the art will recognize that underlying computing and networking hardware—such as servers, routers, Wi-Fi access points, and storage devices—supports these logical elements. An example configuration of such hardware is shown in FIG. 2 as computing system 200.

Although FIG. 1 specifically illustrates a scenario where a CA 104 provides certificate management APIs 106 for a customer site 102, the same principles apply to any machine-to-machine API calls where no direct human involvement is possible. These second-factor techniques offer an additional layer of security to ensure that a compromised first-factor credential alone is insufficient for unauthorized access.

The computing environment 100 includes a configuration console 110, which can be hosted as a cloud-based service by the CA 104 or deployed in another suitable manner. Initially, the customer uses this console 110 to enroll and configure a list of Wi-Fi networks 112 that exist at the physical customer site 102. These Wi-Fi networks 112 serve as the basis for verifying the customer's physical location.

Once the list of Wi-Fi networks 112 is registered, the configuration console 110 securely deploys a library 114 to the customer site 102 via an encrypted configuration file 116. This library 114 may reside on a server that is permitted to access those Wi-Fi networks 112 and is physically located at the customer premises. The same server can also host the customer application 108, or alternatively, the library 114 and the customer application 108 can run on different machines within the same local network. In either case, the essential requirement is that the library 114 is installed on a trusted system at the legitimate customer's physical site with the capability to log into or detect the designated Wi-Fi networks.

Following the enrollment and setup, the customer application 108 calls the library 114 before it executes any standard API operation on the API 106. The library 114 attempts to verify physical proximity by detecting (and optionally authenticating to) the Wi-Fi networks 112 defined in the encrypted configuration file 116. Importantly, this verification goes beyond simply matching the Wi-Fi network name or service set identifier (SSID); it may involve checking unique identifiers (such as BSSIDs), performing a handshake, or using other device-level checks to confirm that the environment is genuine and not being spoofed.

If the library 114 successfully confirms the correct Wi-Fi networks 112, it generates an encrypted, nonced data block 118. This data block contains cryptographic elements (e.g., time stamps, nonces, and signatures) to thwart replay attacks and to ensure it cannot be forged by adversaries. The customer application 108 includes this data block 118 as an optional parameter (or header) in its normal API request. The request also includes a conventional first-factor authentication method—such as an API key, an OAuth token, or mutual TLS—ensuring that both factors must be validated.

On the CA's side, the API 106 and associated servers receive the request and decrypt or verify the data block 118. A confirmation module 120 and associated database 122 maintain the records necessary to validate the data block 118. If these servers confirm that (1) the first-factor credentials are valid, and (2) the nonced data block 118 indeed indicates legitimate physical proximity to the customer site 102, the API server grants the requested operation. This dual check ensures that a stolen credential alone is inadequate for spoofing access unless the attacker is also within (or convincingly emulating) the legitimate customer's Wi-Fi network 112. Consequently, the disclosed approach delivers robust security while preserving fully automated API workflows, as no human interaction is required once the system is configured.

### Implementation Overview

The customer can be an enterprise, a service provider, or any organization hosting a customer application 108 at the customer site 102. Registration is performed in advance of any API calls, during which the customer pre-registers Wi-Fi networks 112. These networks include a set of Wi-Fi access points or network identifiers that act as a “location fingerprint” for the customer's physical site 102. The library 114 (i.e., client-side software agent) on the API client device is configured to recognize these authorized Wi-Fi network signatures. Before each sensitive API operation, the library 114 checks if it is in the correct physical location by detecting those Wi-Fi networks 112. Only if this environment verification succeeds does it proceed to authenticate to the API 106. This location-based factor is used in addition to a standard first-factor credential (such as an API key, OAuth token, or client certificate), forming a layered security model.

The location-based second-factor authentication proceeds through the following steps, which are automatically executed by the customer application 108 and the library 114, and verified by the CA 104:
(1) Wi-Fi-Based Proximity Verification: The client-side software (i.e., the library 114) scans for nearby wireless networks (Wi-Fi access points) and checks for the presence of one or more pre-authorized Wi-Fi networks 112. Each authorized network is identified by unique attributes such as its SSID and BSSID (the Media Access Control (MAC) address of the wireless access point). For example, the enterprise might designate “CorpNetwork-5G” with a specific BSSID as a required signal. If the client detects the expected Wi-Fi beacon(s), it concludes that it is within the predefined physical premises (e.g., inside the corporate office at the customer site 102). This proximity check functions as the second factor—essentially “something the environment has.” If none of the authorized Wi-Fi networks 112 are detected, the client aborts the process, thereby preventing API usage from an untrusted location.
(2) Encrypted Authentication Token Generation: Upon verifying the correct location, the library 114 compiles a small data packet containing authentication metadata. This packet may include details like a device identifier, a timestamp or nonce (to prevent replay attacks), and an indication of which authorized Wi-Fi networks 112 were detected. The client then cryptographically encrypts or signs this data block 118 using a secret key or certificate that is shared with (or trusted by) the API server. Encryption ensures the token's contents cannot be read or manipulated by an attacker. Embedding a timestamp and one-time nonce makes the token immune to replay attacks—even if an attacker intercepts a valid token, it cannot be reused later because the server will detect it as duplicate or expired. Similarly, an attacker cannot forge a valid token without the correct cryptographic key. This step creates a one-time, secure authentication token proving, for example, “this request originated from a device at location X at time Y.”
(3) Transmission to the API 106 Server: The customer application 108 attaches the encrypted token to the API request when contacting the secure API 106 server. This can be done by including the token in an HTTP header, within the message payload, or as part of a security envelope (e.g., in a SOAP header or JWT claim). The API request also includes the standard first-factor credential (e.g., an API key or certificate), while the token acts as a second piece of evidence for the server to validate. Typically, the client and server communicate over TLS/HTTPS, so both the request and the token remain protected against eavesdropping or man-in-the-middle attacks. From the server's perspective, each incoming API call thus contains both the usual authentication data and an extra encrypted block claiming physical proximity.
(4) Server-Side Verification: When the API 106 server receives the request, it performs multi-step verification. First, it checks the primary credentials (e.g., whether the API key or client certificate corresponds to a known client). Next, it decrypts or verifies the signature on the received token using the server-side cryptographic key. If decryption or signature validation fails, the token is deemed invalid and the request is denied. If decryption succeeds, the server checks the token's contents: it confirms that the token is recent (the timestamp is within an acceptable range), not previously used (the nonce is unique), and that the Wi-Fi network 112 identifiers match those assigned to that specific client. This final check ensures the request truly originates from a device physically located at the authorized customer site at the current time. Only if all these validations pass does the server consider the second-factor authentication successful and allow the API call to proceed. Conversely, if any check fails—whether the token is missing, expired, reused, or contains incorrect data—the server rejects the request as unauthorized.

### Security Mechanisms and Considerations

This Wi-Fi proximity-based MFA scheme introduces several security mechanisms to ensure robustness:
(1) Cryptographic Protection: The use of encryption and/or digital signatures on the authentication token guarantees its integrity and authenticity. Only the genuine client (with access to the secret key or private key) can generate a token that the server will accept. Likewise, only the server (with the corresponding key) can decrypt or verify it. This prevents attackers from forging a valid location token or altering one. Even if an attacker somehow sniffs the token in transit, it cannot be deciphered or reused due to its encrypted nature and embedded nonce/timestamp.
(2) Replay Attack Prevention: Including a timestamp and a nonce (a random unique number) in the token data is critical for preventing replay attacks. The server will reject tokens that are outside a short time window or that have already been seen. This means an attacker cannot simply capture a valid token from a legitimate request and replay it later to gain access. Each token is one-time-use and time-limited. Even if credentials and a past token were stolen, they would not be useful to authenticate outside the valid time frame and location.
(3) Binding to Physical Location: The presence of specific Wi-Fi networks 112 serves as a proxy for physical location. An attacker operating remotely (not at the customer's site) would generally have no way to detect or impersonate these Wi-Fi signals. The network identifiers (especially BSSIDs) are typically unique to the hardware at the site. Unless an attacker is physically present at the same location (or has set up specialized equipment to spoof the exact Wi-Fi environment, which is highly unlikely and difficult), they cannot satisfy the proximity check. This binding significantly raises the bar for attackers—stealing credentials alone is not enough; they would also need to breach physical security or network environment controls.
(4) No Human Involvement Required: All the above checks happen transparently in software, which preserves the automation. The client device itself enforces the rule “only call the API if I'm on the right network” and the server double-checks that claim. There is no need for a user to input anything or for an administrator to manually approve requests in real time. This is crucial for use cases like automated certificate renewal or large-scale transaction processing, where human intervention is infeasible.
(5) Integration with Existing Infrastructure: This solution leverages existing Wi-Fi infrastructure as an authentication signal. Enterprises normally already have secure Wi-Fi in their offices, and client devices usually have Wi-Fi capability. The solution only requires deploying the client-side agent software and configuring known network identifiers—no specialized hardware tokens or new authentication servers are needed beyond possibly extending the API server to handle the token verification. This use of familiar technologies (Wi-Fi scanning and encryption) makes the solution easier to adopt and less prone to compatibility issues.

### Benefits of the Location-Based Approach

Implementing a second-factor authentication based on physical proximity provides several key benefits for securing APIs:
(1) Enhanced Security: Even if API keys or credentials are compromised, an attacker cannot use them to access the API from an unauthorized location. This dramatically reduces the risk of fraudulent API calls, as both “something you know” (credentials) and “something you have/are” (presence in the right environment) are required. It protects sensitive operations (like financial transactions or certificate management) from remote exploitation.
(2) Preserves Automation (Seamless machine-to-machine Interaction): Unlike traditional MFA, this method does not interrupt or slow down the API client with interactive prompts. The second factor check is done in the background by the machine. This means automated processes, batch jobs, or continuous integration systems can use the API without human support, maintaining efficiency and speed.
(3) Location-Based Access Control: It enforces a form of geofencing for API usage. Organizations can tightly control that certain API functions only execute on-premises or in specific trusted network zones. This is especially useful for compliance-for example, ensuring that sensitive data operations only happen from within a company's facilities or data centers.
(4) No Additional Hardware Needed: The approach takes advantage of existing Wi-Fi networks 112 and the device's wireless capability. There is no need for special GPS units, hardware tokens, or biometric scanners on the machine. The client just needs the ability to scan for Wi-Fi (which virtually all laptops, servers, or IoT devices have if they are wireless-enabled) and the software to perform the check. This makes the solution cost-effective to deploy at scale.
(5) Scalable and Cost-Effective: Rolling out this second factor to many API clients is primarily a software update and configuration task. Once the server component is in place, new clients can be provisioned with the list of authorized networks and keys. There's minimal overhead per client beyond maintaining the list of authorized Wi-Fi identifiers. It scales well for enterprises with many devices and does not incur per-user licensing costs that some other MFA solutions might have.
(5) Complements Existing Security: This mechanism is additive—it works alongside standard authentication methods (like API keys, OAuth tokens, or TLS client certificates). It does not replace them, but adds another layer. This layered (defense-in-depth) approach means even if one layer fails, the other continues to protect the system. The overall authentication framework becomes much more robust without redesigning the entire system.

The Wi-Fi proximity-based second-factor authentication for APIs provides a practical solution to a tough problem: how to do MFA for machine-only interactions. By using the client device's physical location as an additional factor, we achieve a high level of security that mitigates credential theft risks, all while keeping the process fully automated. The API client effectively authenticates “who it is” (via credentials) and “where it is” (via location verification). This approach is especially valuable for enterprises and services handling sensitive operations through APIs, such as the management of digital certificates, financial transactions, or critical configuration changes. It offers a balanced combination of security, ease of deployment, and minimal impact on existing workflows, thereby providing a scalable and robust solution for protecting machine-to-machine API communications.

### Resilience to Spoofing and Alternative Approaches

Merely copying the Wi-Fi name (SSID) is not sufficient to fool this system, because it performs deeper checks that may involve verifying the router's unique hardware attributes (e.g., BSSID/MAC address) or conducting a cryptographic handshake to confirm genuine proximity. In other words, even if an attacker broadcasts the same SSID, they cannot perfectly replicate the router's underlying hardware signature or respond correctly to cryptographic challenges without physical access to the legitimate router. This physical requirement raises the security bar significantly, as an attacker must either be within Wi-Fi range of the authorized site or implement a highly sophisticated spoofing setup that precisely clones both the Wi-Fi signal characteristics and cryptographic responses.

By contrast, alternative solutions—such as IP allowlisting or geolocation checks—are generally less robust. IP-based methods can be bypassed if an attacker gains a foothold on the allowed network or uses techniques like IP spoofing, NAT traversal, or VPN tunneling to masquerade as a trusted source. Likewise, geolocation data can be inaccurate or easily faked, especially if the underlying infrastructure relies on user device settings or public IP mappings. The Wi-Fi/hardware-based approach not only enforces a stricter physical proximity requirement but also ties authentication to specific hardware attributes, reducing the likelihood of remote impersonation or location spoofing.

### Example Computing System Architecture and Cloud Deployment

FIG. 2 is a block diagram of a computing system 200 that may be used to implement various components described in this disclosure. The computing system 200 can be implemented in many forms, including laptops, desktops, physical servers, clusters of machines, virtual machines (VMs) running on hypervisors, or serverless computing frameworks. Regardless of the underlying infrastructure, the computing system 200 typically includes one or more processors 202, input/output (I/O) interfaces 204, a network interface 206, a data store 208, and memory 210. Note that FIG. 2 provides a simplified representation; in practice, the computing system 400 may include additional hardware and software elements. These components 202, 204, 206, 208, 210 are connected via a local interface 212, which can include various wired or wireless buses, high-speed interconnects, or switching fabrics. The local interface 212 may also include controllers, buffers, caches, drivers, repeaters, and receivers, along with addressing and control lines that facilitate efficient communication and resource sharing among components.

Each processor 202 is a hardware element—such as a central processing unit (CPU), multicore processor, system-on-chip (SoC), graphics processing unit (GPU), or a processing element within a larger compute cluster—designed to execute software instructions. These processors may be general-purpose or specialized, depending on performance, power efficiency, or workload needs. During operation, each processor 202 retrieves and executes instructions stored in memory 210, manages data exchanges with the data store 208, and oversees system 200 operations. In large-scale environments, multiple processors 202 may operate in parallel to handle elevated traffic and complex workloads.

The I/O interfaces 204 enable the computing system 200 to interact with external peripherals, allowing user input (e.g., via keyboards, touchscreens, or sensors) and system output (e.g., to displays or printers). Depending on the application, these I/O interfaces 204 may also support specialized devices used for maintenance, debugging, or other administrative functions. Meanwhile, the network interface 206 handles connectivity to external networks, which may include the Internet, private networks, or cloud environments. This network interface can use Ethernet, wireless local area networks (LANs), cellular connections, or virtualized cloud interfaces. By using secure transport protocols and encryption, data transmitted via the network interface 206 can remain protected, enabling the computing system 200 to participate safely in distributed or cloud-based deployments.

The data store 208 provides storage for both persistent and temporary data. It may include volatile memory (e.g., random access memory (RAM)) for high-speed operations and nonvolatile media (e.g., solid-state drives, hard disk drives, optical media) for long-term retention. In some deployments, the data store 208 may integrate with network-attached storage (NAS), storage area networks (SAN), or cloud-based storage solutions. These configurations can range from modest local setups to large-scale installations, potentially featuring global deduplication, compression, encryption at rest, and multi-site replication. The data store 208 can hold operational logs, configuration details, policy rules, program binaries, and cached computation results.

The memory 210 typically serves as the primary working memory for the processors 202. It may be composed of volatile elements (e.g., dynamic RAM (DRAM), double data rate (DDR), synchronous DRAM (SDRAM)) for fast access, as well as nonvolatile components such as flash memory or non-volatile RAM (NVRAM). The memory 210 can be distributed across nodes or servers to support the large-scale in-memory processing demanded by modern cloud services. Generally, the memory 210 stores the operating system (O/S) 214 and one or more programs 216. The O/S 214 handles core system tasks such as process scheduling, memory allocation, file management, and networking.

For Software-as-a-Service (SaaS) or other cloud-based components, the computing system 200 can be deployed in various ways: as a private cloud in a single organization's datacenter, a public cloud hosted by a third-party provider, or a hybrid cloud that combines both approaches for specific security, performance, or compliance considerations. Cloud computing abstracts physical hardware—servers, storage devices, and networks—into on-demand, scalable resources. This allows organizations to provision computing power, storage, and network bandwidth with minimal upfront costs, adjusting to fluctuating workloads seamlessly. According to the U.S. National Institute of Standards and Technology (NIST), cloud computing is “a model for enabling convenient, on-demand network access to a shared pool of configurable computing resources (e.g., networks, servers, storage, applications, and services) that can be rapidly provisioned and released with minimal management effort or service provider interaction.” Unlike traditional client-server environments, cloud computing typically delivers applications via a web interface, reducing the need for local installations and updates. Centralizing application hosting allows providers to uniformly release new features, apply security patches, and manage licensing. By using these SaaS models, end users can access software via browsers or lightweight clients, taking advantage of continuous improvements and frequent updates.

Various embodiments may utilize different forms of processing circuitry—general-purpose microprocessors, CPUs, digital signal processors (DSPs), network processors, GPUs, field programmable gate arrays (FPGAs), programmable logic devices (PLDs), or similar. This circuitry may be controlled by software, firmware, or a combination thereof, possibly alongside non-processor circuits to achieve the desired functionality. Specific tasks can also be handled by state machines or one or more application-specific integrated circuits (ASICs) that implement dedicated logic. In some cases, a hybrid approach may be adopted. Additionally, implementations can include a non-transitory computer-readable storage medium that stores computer-readable instructions. When executed by a device containing suitable processing circuitry, these instructions cause the system to perform the methods or algorithms described in this disclosure. Non-limiting examples of such storage media include hard disks, optical disks, magnetic devices, read-only memory (ROM) and its variants, flash memory, or other persistent/semi-persistent storage. Once stored, these instructions enable execution of the disclosed methods.

### Process

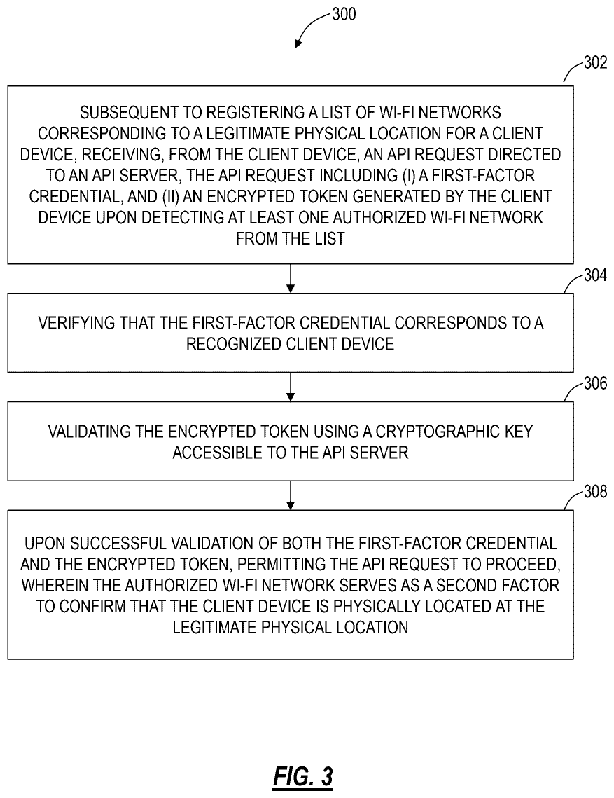

FIG. 3 illustrates a flowchart of a process 300 for providing second-factor authentication for an application programming interface (API) in a computing environment. In various embodiments, the process 300 can be implemented in multiple ways: as a method comprising distinct steps, in the computing environment 100 and via the computing system 200 configured to execute those steps, via a cloud system configured to do so, or through a non-transitory computer-readable medium that stores instructions causing one or more processors to perform the steps. This flexibility allows process 300 to be adapted to various system architectures and deployment scenarios.

The steps include, subsequent to registering a list of Wi-Fi networks corresponding to a legitimate physical location for a client device, receiving, from the client device, an API request directed to an API server, the API request including (i) a first-factor credential, and (ii) an encrypted token generated by the client device upon detecting at least one authorized Wi-Fi network from the list (step 302); verifying that the first-factor credential corresponds to a recognized client device (step 304); validating the encrypted token using a cryptographic key accessible to the API server (step 306); and, upon successful validation of both the first-factor credential and the encrypted token, permitting the API request to proceed, wherein the authorized Wi-Fi network serves as a second factor to confirm that the client device is physically located at the legitimate physical location (step 308).

The registering of the list of Wi-Fi networks can include receiving user input specifying at least one network identifier including one of a service set identifier (SSID), a basic service set identifier (BSSID), a media access control (MAC) address, or a hashed network fingerprint. The steps can further include embedding a time-limited nonce in the encrypted token, the nonce expiring after a predetermined interval, wherein the API server rejects the API request if the nonce is expired or duplicated. The detecting at least one authorized Wi-Fi network can include performing a wireless scan to locate a unique BSSID corresponding to an on-premises access point, such that merely copying the SSID name is insufficient to pass the second factor check. Thee validating the encrypted token can include decrypting or verifying a digital signature of the token using the cryptographic key at the API server, and rejecting the API request if decryption or signature validation fails.

The steps can further include conducting a local handshake with the at least one authorized Wi-Fi network prior to generating the encrypted token, wherein successful completion of the handshake confirms physical proximity and prevents SSID spoofing. The first-factor credential can be one of (a) an API key, (b) an OAuth bearer token, (c) HTTP basic credentials, or (d) a mutual TLS (Transport Layer Security) client certificate. The permitting the API request to proceed can include granting access to at least one certificate management function provided by a certificate authority (CA), thereby restricting such operations to devices detected within the legitimate physical location.

The steps can further include encrypting all communication between the client device and the API server, including the first-factor credential and the encrypted token, using a secure transport layer protocol to protect against eavesdropping or man-in-the-middle attacks. The steps can further include generating the encrypted token on the client device using a hardware security module or a trusted platform module (TPM), such that private keys are stored in a tamper-resistant environment. The failing to validate the encrypted token causes the API server to deny the request due to at least one of (a) a missing or invalid Wi-Fi network identifier, (b) an expired or reused nonce, (c) an invalid digital signature, or (d) an incomplete token field. The steps can further include automatically updating the list of Wi-Fi networks at scheduled intervals via a secure configuration console, wherein the client device receives revised network data to accommodate Wi-Fi changes at the legitimate physical location.

The encrypted token can contain a device identifier unique to the client device, and the API server verifies that the device identifier appears in a registry of approved devices prior to granting the API request. The steps can further include maintaining an audit log of all token validation outcomes, including timestamps, Wi-Fi network identifiers, and client device identifiers, for subsequent security analysis or compliance review. The steps can further include enforcing different levels of API privileges based on which authorized Wi-Fi network is detected, allowing more restricted access if the client device is connected to a guest network or partial coverage area within the legitimate physical location. The steps can further include the encrypted token includes confirming a cryptographic proof of proximity against specific hardware attributes of the authorized Wi-Fi network, thereby preventing an attacker from passing second-factor authentication by merely replicating the network's SSID.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method for providing second-factor authentication for an application programming interface (API) in a computing environment, the method comprising:
subsequent to registering a list of Wi-Fi networks corresponding to a legitimate physical location for a client device, receiving, from the client device, an API request directed to an API server, the API request including (i) a first-factor credential, and (ii) an encrypted token generated by the client device upon detecting at least one authorized Wi-Fi network from the list;
verifying that the first-factor credential corresponds to a recognized client device;
validating the encrypted token using a cryptographic key accessible to the API server; and
upon successful validation of both the first-factor credential and the encrypted token, permitting the API request to proceed, wherein the authorized Wi-Fi network serves as a second factor to confirm that the client device is physically located at the legitimate physical location.

2. The method of claim 1, wherein the registering of the list of Wi-Fi networks includes receiving user input specifying at least one network identifier including one of a service set identifier (SSID), a basic service set identifier (BSSID), a media access control (MAC) address, or a hashed network fingerprint.

3. The method of claim 1, further comprising embedding a time-limited nonce in the encrypted token, the nonce expiring after a predetermined interval, wherein the API server rejects the API request if the nonce is expired or duplicated.

4. The method of claim 1, wherein the detecting at least one authorized Wi-Fi network includes performing a wireless scan to locate a unique BSSID corresponding to an on-premises access point, such that merely copying an SSID name is insufficient to pass the.

5. The method of claim 1, wherein the validating the encrypted token includes decrypting or verifying a digital signature of the token using the cryptographic key at the API server, and rejecting the API request if decryption or signature validation fails.

6. The method of claim 1, further comprising conducting a local handshake with the at least one authorized Wi-Fi network prior to generating the encrypted token, wherein successful completion of the handshake confirms physical proximity and prevents SSID spoofing.

7. The method of claim 1, wherein the first-factor credential is one of
(a) an API key,
(b) an OAuth bearer token,
(c) HTTP basic credentials, or
(d) a mutual TLS (Transport Layer Security) client certificate.

8. The method of claim 1, wherein the permitting the API request to proceed includes granting access to at least one certificate management function provided by a certificate authority (CA), thereby restricting such operations to devices detected within the legitimate physical location.

9. The method of claim 1, further comprising encrypting all communication between the client device and the API server, including the first-factor credential and the encrypted token, using a secure transport layer protocol to protect against eavesdropping or man-in-the-middle attacks.

10. The method of claim 1, further comprising generating the encrypted token on the client device using a hardware security module or a trusted platform module (TPM), such that private keys are stored in a tamper-resistant environment.

11. The method of claim 1, wherein failing to validate the encrypted token causes the API server to deny the request due to at least one of:
(a) a missing or invalid Wi-Fi network identifier,
(b) an expired or reused nonce,
(c) an invalid digital signature, or
(d) an incomplete token field.

12. The method of claim 1, further comprising automatically updating the list of Wi-Fi networks at scheduled intervals via a secure configuration console, wherein the client device receives revised network data to accommodate Wi-Fi changes at the legitimate physical location.

13. The method of claim 1, wherein the encrypted token contains a device identifier unique to the client device, and the API server verifies that the device identifier appears in a registry of approved devices prior to granting the API request.

14. The method of claim 1, further comprising maintaining an audit log of all token validation outcomes, including timestamps, Wi-Fi network identifiers, and client device identifiers, for subsequent security analysis or compliance review.

15. The method of claim 1, further comprising enforcing different levels of API privileges based on which authorized Wi-Fi network is detected, allowing more restricted access if the client device is connected to a guest network or partial coverage area within the legitimate physical location.

16. The method of claim 1, wherein validating the encrypted token includes confirming a cryptographic proof of proximity against specific hardware attributes of the authorized Wi-Fi network, thereby preventing an attacker from passing second-factor authentication by merely replicating a network's SSID.

17. A non-transitory computer-readable medium storing instructions for providing second-factor authentication for an application programming interface (API) in a computing environment, the instructions, when executed, cause one or more processors in the computing environment to perform steps of:
subsequent to registering a list of Wi-Fi networks corresponding to a legitimate physical location for a client device, receiving, from the client device, an API request directed to an API server, the API request including (i) a first-factor credential, and (ii) an encrypted token generated by the client device upon detecting at least one authorized Wi-Fi network from the list;
verifying that the first-factor credential corresponds to a recognized client device;
validating the encrypted token using a cryptographic key accessible to the API server; and
upon successful validation of both the first-factor credential and the encrypted token, permitting the API request to proceed, wherein the authorized Wi-Fi network serves as a second factor to confirm that the client device is physically located at the legitimate physical location.

18. The non-transitory computer-readable medium of claim 17, wherein the registering of the list of Wi-Fi networks includes receiving user input specifying at least one network identifier including one of a service set identifier (SSID), a basic service set identifier (BSSID), a media access control (MAC) address, or a hashed network fingerprint.

19. The non-transitory computer-readable medium of claim 17, wherein the steps further include embedding a time-limited nonce in the encrypted token, the nonce expiring after a predetermined interval, wherein the API server rejects the API request if the nonce is expired or duplicated.

20. The non-transitory computer-readable medium of claim 17, wherein the detecting at least one authorized Wi-Fi network includes performing a wireless scan to locate a unique BSSID corresponding to an on-premises access point, such that merely copying an SSID name is insufficient to pass.
